(19) United States
(12) Patent Application Publication
(10) Pub. No.: US 2018/0022003 A1
(43) Pub. Date: Jan. 25, 2018

(54) INJECTION MOLDING METHOD, SCREW FOR INJECTION MOLDING MACHINE, AND INJECTION MOLDING MACHINE

(71) Applicants: U-MHI PLATECH CO., LTD., Nagoya-shi (JP); MITSUBISHI HEAVY INDUSTRIES, LTD., Tokyo (JP)

(72) Inventors: Munehiro NOBUTA, Aichi (JP); Naoki TODA, Aichi (JP); Toshihiko KARIYA, Aichi (JP); Takeshi YAMAGUCHI, Aichi (JP); Kiyoshi KINOSHITA, Aichi (JP)

(21) Appl. No.: 15/543,783

(22) PCT Filed: Jan. 16, 2015
(86) PCT No.: PCT/JP2015/000167

§ 371 Date: Jul. 14, 2017

(51) Int. Cl. B29C 45/60; B29C 45/50; B29C 45/00

(52) U.S. Cl. CPC B29C 45/60; B29C 45/0005; B29C 45/50; B29K 2101/12

(57) ABSTRACT

Provided is an injection molding method in which a constricting section is provided at a boundary between a first stage and a second stage of a screw. When a mixture of a molten resin and reinforcing fibers passes through the constricting section, compression force higher than compression force on an upstream side of the constricting section is applied to the mixture. A supply section on a downstream side of the constricting section has a shaft diameter smaller than an outer diameter of the constricting section. Therefore, the vicinity of the supply section becomes a reduced-pressure region with respect to the mixture having passed through the constricting section, and the mixture is accordingly expanded. As a result, spring-back occurs on the reinforcing fibers and a Barus effect occurs on the molten resin, thereby making it possible to produce a state that is advantageous to open the fiber bundle.

### TECHNICAL FIELD

The present invention relates to injection molding of a resin containing reinforcing fibers.

### BACKGROUND ART

A molded product of a fiber-reinforced resin that is enhanced in strength by containing reinforcing fibers is used for various applications. The molded product is fabricated by injecting a mixture of reinforcing fibers and a thermoplastic resin into a mold of an injection molding machine. The thermoplastic resin has been melted, through rotation of a screw, in a cylinder serving as a plasticization apparatus.

To achieve strength improvement effect by the reinforcing fibers, it is desirable to uniformly disperse the reinforcing fibers into the resin.

In contrast, Patent Literature 1 discloses a screw for injection molding that is supplied with, at a position corresponding to a screw base part on an upstream side, a resin raw material and reinforcing fibers that are separately prepared and plasticizes and melts the resin raw material and the reinforcing fibers. The screw includes one supply section, one compression section, and one measurement section, and further includes a mixing at a font end, thereby kneading and dispersing the molten resin and the reinforcing fibers.

Further, Patent Literature 2 suggests that a raw material compression section is provided in a measurement section of a screw or at a position on a downstream side of the measurement section. The raw material compression section has a shaft diameter larger than a shaft diameter of other parts to decrease passage cross-sectional area of a mixture of a molten resin and reinforcing fibers. The raw material compression section drastically compresses the mixture conveyed from the upstream side to apply shearing force to the mixture, thereby promoting mixing and dispersion of the reinforcing fibers in the molten resin.

### CITATION LIST

### Patent Literature

Patent Literature 1: Japanese Patent Laid-Open No. 8-156055
Patent Literature 2: Japanese Patent Laid-Open No. 2002-248664

### SUMMARY OF INVENTION

### Technical Problem

The supplied reinforcing fibers form a bundle and the bundle reaches the inside of the cylinder. Opening of the fiber bundle is important in order to evenly disperse the reinforcing fibers.

In Patent Literature 1, however, the fibers forming the bundle are crushed and tightened due to resin compression pressure by the compression section of the screw. Therefore, it is difficult to open the fiber bundle even when shearing force through the rotation of the screw, positional replacement by the front end mixing, and the like are applied to the fiber bundle. The fiber bundle is mixed into a molded product finally obtained, which results in quality defect of the molded product. In addition, if the fiber bundle that has not been sufficiently opened remains in the mixture, the fiber bundle may partially clog an injection port of a nozzle that is a small-bore flow path, which generates flow resistance when the mixture is injected into the cavity of the mold. In this case, excessively-high pressure is necessary to fill the cavity with the mixture and the flow speed of the mixture in filling is also decreased. As a result, the cavity is not sufficiently filled with the mixture, which may generate a defective molded product of which shape has a partial defect due to filling insufficiency.

Likewise, in Patent Literature 2, the fibers are crushed and tightened during the process in which the fibers pass through the raw material compression section having a small passage cross-sectional area. Even if the fibers receive the shearing force in the raw material compression section, the fibers are not sufficiently opened. Therefore, also in Patent Literature 2, the fiber bundle may be mixed into the molded product, which may cause quality defect of the molded product. In particular, in Patent Literature 2, a backflow prevention valve is provided on the downstream side of the screw, and a molten resin flow path inside the backflow prevention valve is typically narrow. Therefore, even if the fiber bundle that has not been sufficiently opened remains in the mixture, the fiber bundle may partially block the flow path, which may cause clogging. In this case, deterioration of plasticization performance or a state of being unable to perform plasticization (being unable to perform measurement) may occur. Furthermore, the fiber bundle may be caught by a flow path closing part of the backflow prevention valve in injection to cause flow path closing failure, which may not prevent backflow of the mixture toward the screw. In this case, the amount of the molten resin that has been plasticized and measured to a predetermined amount is decreased, which generates a defective molded product of which shape has a partial defect due to filling insufficiency.

Accordingly, an object of the present invention is to provide an injection molding method that makes it possible to open fibers even if the fibers have been crushed and tightened.

In addition, an object of the present invention is to provide a screw for an injection molding machine and an injection molding machine that are suitable for such an injection molding method.

### Solution to Problem

The present inventors conceived that reducing pressure applied to the mixture of the fiber bundle and the molten resin after application of compression causes spring-back phenomenon on the fiber bundle and causes a Barus effect on the molten resin to expand the mixture, and the mixture is then kneaded through rotation of the screw, which opens fibers of the fiber bundle.

Specifically, an injection molding method according to the present invention, includes: a plasticization step of supplying a solid resin raw material and reinforcing fibers to a cylinder including a screw, and rotating the screw in a normal direction to generate a mixture of the reinforcing fibers and a molten resin, the screw being rotatable around a rotation axis and being movable forward and rearward along the rotation axis; and an injection step of injecting the mixture of the reinforcing fibers and the molten resin into a cavity of a mold, in which, in the plasticization step, compression force that is higher than compression force on an upstream side of a constricting region is applied to the mixture of the reinforcing fibers and the molten resin in the constricting region, the constricting region being provided in at least a portion of the screw in the rotation axis direction, the pressure applied to the mixture is reduced in a reduced-pressure region on a downstream side of the constricting region, and the mixture is kneaded through the rotation of the screw.

In the plasticization step according to the present invention, the solid resin raw material and the reinforcing fibers may be supplied on the upstream side of the constricting region, and the mixture of the reinforcing fibers and the molten resin may be generated until the resin raw material and the reinforcing fibers reach the constricting region.

In the injection molding method according to the present invention, the screw may include a constricting section, a reduced-pressure section, and a kneading section. The constricting section may be provided in at least a partial region through which the generated mixture passes and have an outer diameter D₂ that is larger than a shaft diameter D₁ of the screw on the upstream side of the partial region, the reduced-pressure section may be continuous with the constricting section on the downstream side and have a shaft diameter D₃ that is smaller than the outer diameter D₂ of the constricting section, and the kneading section may be continuous with a downstream end of the reduced-pressure section and knead the mixture. In this case, the constricting region may be provided around the constricting section inside the cylinder, the expansion region may be provided around the reduced-pressure section inside the cylinder, and the kneading section may be provided around the expansion region inside the cylinder.

The screw may preferably have a ratio of the shaft diameter D₃ to the outer diameter D₂ (the shaft diameter D₃/the outer diameter D₂) within a range of 0.5 to 0.95.

Further, the screw may have the shaft diameter D₃ of the reduced-pressure section smaller than the shaft diameter D₁ of the screw on the upstream side of the constricting section.

Moreover, a screw for an injection molding machine according to the present invention is used to inject and mold a mixture of a molten resin and reinforcing fibers to generate a fiber-reinforced resin. The screw includes: a melting section that plasticizes and melts a solid resin raw material to generate the mixture of the molten resin and the reinforcing fibers; a constricting section that is provided in at least a partial region through which the generated mixture passes, and has an outer diameter larger than a shaft diameter of the screw on an upstream side of the partial region; a reduced-pressure section that is continuous with the constricting section on a downstream side, and has the shaft diameter smaller than the outer diameter of the constricting section; and a kneading section that is continuous with a downstream end of the reduced-pressure section and kneads the mixture through rotation of the screw.

In the screw, the constricting section may be preferably formed in a ring shape that has the outer diameter larger than the shaft diameter of the screw over an entire circumference. In addition, the constricting section may preferably include a main flight and a sub-flight that has an outer diameter set smaller than an outer diameter of the main flight, and the sub-flight may preferably have a lead angle that is set larger than a lead angle of the main flight, and have both ends that are closed with respect to the main flight.

Furthermore, an injection molding machine according to the present invention injects and molds a fiber-reinforced resin. The injection molding machine includes: a cylinder including a discharge nozzle; and a screw that is provided inside the cylinder, is rotatable around a rotation axis, and is movable forward and rearward along the rotation axis, in which the screw includes a melting section that plasticizes and melts a solid resin raw material to generate a mixture of a molten resin and reinforcing fibers, a constricting section that is provided in at least a partial region through which the generated mixture passes, and has an outer diameter larger than a shaft diameter of the screw on an upstream side of the partial region, a reduced-pressure section that is continuous with the constricting section on a downstream side, and has the shaft diameter smaller than the outer diameter of the constricting section, and a kneading section that is continuous with a downstream end of the reduced-pressure section and kneads, through rotation of the screw, the mixture discharged from the constricting section.

### Advantageous Effects of Invention

According to the present invention, reducing the pressure after application of compression causes the spring-back phenomenon on the fiber bundle and causes the Barus effect on the molten resin to expand the mixture, thereby breaking the bond of the fiber bundle. The mixture is then kneaded through rotation of the screw, which makes it possible to open fibers of the fiber bundle.

### BRIEF DESCRIPTION OF DRAWINGS

FIG. 1 is a diagram illustrating a schematic configuration of an injection molding machine according to the present embodiment.

FIGS. 2A to 2C are diagrams each schematically illustrating a molten state of a resin in respective steps of injection molding according to the present embodiment in which FIG. 2A illustrates the state at start of plasticization, FIG. 2B illustrates the state at completion of the plasticization, and FIG. 2C illustrates the state at completion of injection.

FIGS. 3A to 3C each illustrate, in an enlarged manner, a vicinity of a constricting section of a screw illustrated in FIG. 1 and FIGS. 2A to 2C, FIG. 3B illustrates spring-back phenomenon, and FIG. 3C illustrates a Barus phenomenon of a molten resin.

FIGS. 4A to 4C are diagrams each illustrating a screw that is applicable to the present embodiment in which FIG. 4A illustrates an example of the screw, FIG. 4B illustrates another example of the screw, and FIG. 4C illustrates behavior of the molten resin.

### DESCRIPTION OF EMBODIMENT

The present invention is described in detail below based on an embodiment illustrated in accompanying drawings.

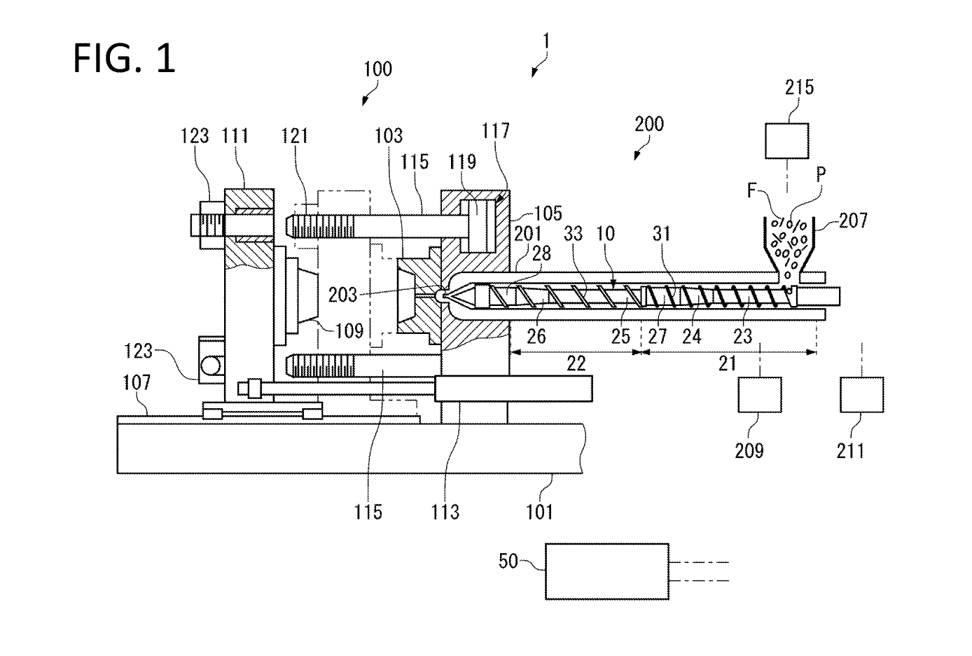

As illustrated in FIG. 1, an injection molding machine 1 according to the present embodiment includes a mold clamping unit 100, a plasticization unit 200, and a control section 50 that controls operation of these units.

Outline of a configuration and operation of the mold clamping unit 100 and a configuration and operation of the plasticization unit 200 are described below, and a procedure of injection molding by the injection molding machine 1 is then described.

### [Configuration of Mold Clamping Unit]

The mold clamping unit 100 includes: a fixed die plate 105 that is fixed on a base frame 101 and is attached with a fixed mold 103; a movable die plate 111 that is moved on a sliding member 107 such as a rail and a sliding plate in a lateral direction of drawing along with operation of a hydraulic cylinder 113 and is attached with a movable mold 109; and a plurality of tie bars 115 that couples the fixed die plate 105 to the movable die plate 111. A mold-clamping hydraulic cylinder 117 is so provided on the fixed die plate 105 as to be coaxial with the tie bars 115, and one end of each of the tie bars 115 is connected to a ram 119 of the hydraulic cylinder 117.

These components perform respective necessary operations according to respective instructions from the control section 50.

### [Operation of Mold Clamping Unit]

Schematic operation of the mold clamping unit 100 is as follows.

First, the movable die plate 111 is moved to a position illustrated by an alternate long and two short dashes line in the drawing through operation of the hydraulic cylinder 113 for mold opening/closing, to bring the movable mold 109 into contact with the fixed mold 103. Next, male screw parts 121 of the respective tie bars 115 are engaged with corresponding half-cut nuts 123 provided on the movable die plate 111 to fix the movable die plate 111 to the tie bars 115. Thereafter, hydraulic pressure of hydraulic oil in an oil chamber on the movable die plate 111 side inside the hydraulic cylinder 117 is enhanced to tighten the fixed mold 103 and the movable mold 109. After mold clamping is performed in such a manner, a molten resin M is injected from the plasticization unit 200 into a cavity of the molds to form a molded product.

A screw 10 according to the present embodiment is of a type in which thermoplastic resin pellets P and reinforcing fibers F that are individually prepared are put into a supply hopper 207 provided near an upstream end of the screw 10 and mixed. The configuration of the mold clamping unit 100 specifically described below, however, is merely an example that does not inhibit application or replacement of other configurations. For example, the hydraulic cylinder 113 is illustrated as an actuator for mold opening/closing in the present embodiment; however, the hydraulic cylinder 113 may be replaced with a combination of a mechanism that converts rotational motion into linear motion and an electric motor such as a servo motor and an induction motor. As the conversion mechanism, a ball screw or a rack-and-pinion may be used. In addition, the mold clamping unit may be replaced with an electric or hydraulic toggle link mold clamping unit as a matter of course.

Note that, in the present embodiment and the present invention, the upstream and downstream are defined on the basis of a direction in which the resin pellets P (the molten resin M) and the reinforcing fibers F are conveyed. The resin pellets P and the reinforcing fibers F are put into the supply hopper 207 provided on the upstream end, and are injected from a discharge nozzle 203 provided on the downstream end into the cavity.

### [Configuration of Plasticization Unit]

The plasticization unit 200 includes: a cylindrical heating cylinder 201; the discharge nozzle 203 provided on the downstream end of the heating cylinder 201; the screw 10 provided inside the heating cylinder 201; and the supply hopper 207 from which the resin pellets P and the reinforcing fibers F are supplied. In addition, the plasticization unit 200 includes a first electric motor 209 that causes the screw 10 to move forward and rearward, and a second electric motor 211 that causes the screw 10 to rotate in a normal direction or in a reverse direction. These components perform respective necessary operations according to respective instructions from the control section 50.

An unillustrated load cell is interposed between an end part (a rear end) on the downstream side of the screw 10 and the first electric motor 209, and detects load that is received by the screw 10 in an axial direction. The plasticization unit 200 configured of the electric motors controls back pressure applied to the screw 10 in plasticization, on the basis of the load detected by the load cell.

The screw 10 is designed as a two-stage type that is similar to a so-called gas vent screw. More specifically, the screw 10 has a first stage 21 provided on the upstream side and a second stage 22 that is continuous with the first stage 21 and is provided on the downstream side. The first stage 21 includes a supply section 23, a compression section 24, and a measurement section 27 in order from the upstream side. The second stage 22 includes a supply section 25, a compression section 26, and a measurement section 28 in order from the upstream side. Further, the screw 10 includes a constricting section 35 between the first stage 21 and the second stage 22. Note that the right side in FIG. 1 is the upstream side, and the left side is the downstream side.

In the screw 10, a first flight 31 is provided in the first stage 12, and a second flight 33 is provided in the second stage 22.

The first stage 21 is designed in such a manner that a screw groove of the flight at the supply section 23 has a large depth, the depth of the screw groove of the flight at the compression section 24 is gradually decreased from the upstream side toward the downstream side, and the screw groove at the measurement section 27 has the smallest depth. Likewise, the second stage 22 is designed in such a manner that the screw groove of the flight at the supply section 25 has a large depth, the depth of the screw groove of the flight at the compression section 26 is gradually decreased from the upstream side toward the downstream side, and the screw groove at the measurement section 28 has the smallest depth.

The first stage 21 melts a resin raw material to generate the molten resin M, and conveys the generated molten resin M to the second stage 22. Therefore, it is desirable for the first stage 21 to have a function of securing conveyance speed of the molten resin M and plasticization capacity.

To obtain the function, the first flight 31 of the first stage 21 may preferably have a flight lead (L1) that is equal to or smaller than a flight lead (L2) of the second flight 33 of the second stage 22, namely, a condition L1≦L2 may be preferably established. Note that the flight lead (hereinafter, simply referred to as the lead) indicates a distance between portions adjacent in front-rear direction of the flight. As a guide, the lead L1 of the first flight 31 may be preferably 0.4 to 1.0 times of the lead L2, and more preferably 0.5 to 0.9 times of the lead L2.

In addition, a width of the second flight 33 may be preferably 0.01 to 0.3 times of the lead L2 (0.01×L2 to 0.3×L2). This is because, when the width of the flight is smaller than 0.01 times of the lead L2, the strength of the second flight 33 is insufficient, and when the width of the flight exceeds 0.3 times of the lead L2, a width of the screw groove becomes small, and the fibers are caught by a flight top and are difficult to fall in the groove.

Further, in addition to the preferable aspect in which the above-described condition L1≦L2 is established, the second flight 33 at, in particular, a part or all of the supply section 25 of the second stage 22 may not be single flight but may be a plurality of flights. In this case, the molten resin M discharged from the first stage 21 is divided and distributed to the screw grooves that are segmented by the plurality of flights, and the fiber bundle and the molten resin M are mixed in each of the screw grooves. Therefore, this is effective to impregnation of the fiber bundle with the molten resin M.

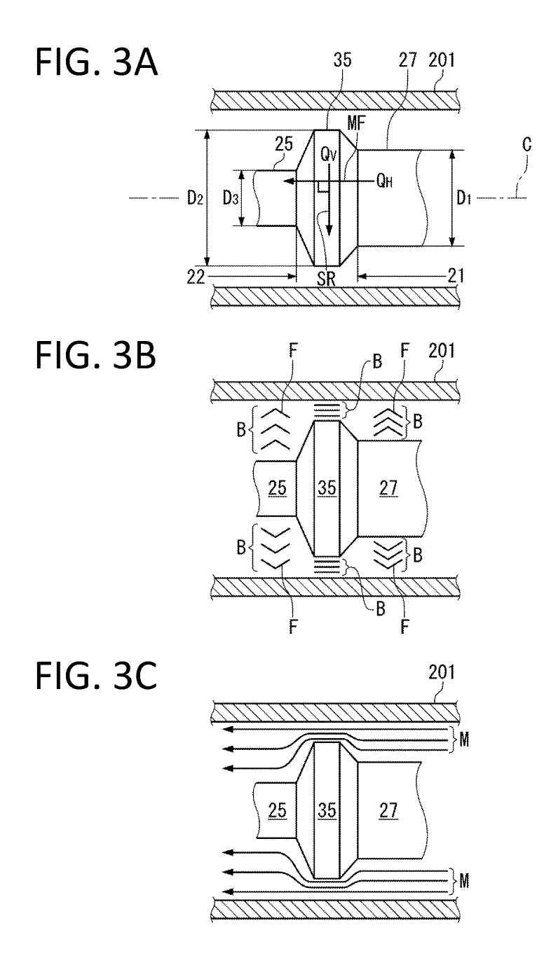

In the screw 10, the constricting section 35 provided between the first stage 21 and the second stage 22 is so designed as to have an outer diameter D₂ larger than a shaft diameter D₁ of the measurement section 27 of the first stage 21 and an outer diameter D₃ of the supply section 25 of the second stage 22, as illustrated in FIG. 3A. As described above, in the vicinity of the constricting section 35, the diameter of the shaft of the screw 10 at the constricting section 35 is enlarged in a radial direction as compared with the measurement section 27, and the diameter of the shaft of the screw 10 is reduced at the supply section 25 that is continuous with the constricting section 35. In addition, the screw 10 is designed in such a manner that the outer diameter D₃ of the supply section 25 of the second stage 22 is smaller than the outer diameter D₁ of the measurement section 27. Enlargement and reduction of the diameter on the upstream side and the downstream side with the constricting section 35 as a boundary makes it possible to apply compression force higher than the pressure at the measurement section 27, to the mixture of the reinforcing fibers and the molten resin that passes through the constricting section 35, and to then reduce pressure applied to the mixture. In other words, a region around the constricting section 35 inside the heating cylinder 201 forms a constricting region of the present invention, and a region around the supply section 25 near the constricting section 35 inside the heating cylinder 201 forms a reduced-pressure region of the present invention. This makes it possible to cause spring-back phenomenon on the fiber bundle, and to cause a Barus effect on the molten resin, that are described in detail later. In addition, illustration of the first flight 31 and the second flight 33 is omitted in FIGS. 3A to 3C.

### [Operation of Plasticization Unit]

Schematic operation of the plasticization unit 200 is as follows, with reference to FIG. 1.

When the screw 10 provided inside the heating cylinder 201 rotates, the pellets (the resin pellets P) made of a thermoplastic resin and the reinforcing fibers F that are supplied from the supply hopper 207 are conveyed toward the discharge nozzle 203 at the downstream end of the heating cylinder 201. In this process, the resin pellets P become the molten resin M. The molten resin M is mixed with the reinforcing fibers F, and the resultant mixture is then injected by a predetermined amount into the cavity that is formed between the fixed mold 103 and the movable mold 109 of the mold clamping unit 100. Note that the basic operation of the screw 10 in which the screw 10 moves rearward while receiving the back pressure and then moves forward to perform injection is performed along with the melting of the resin pellets P as a matter of course. Further, application or replacement of other configurations, for example, installation of a heater to melt the resin pellets P on the outside of the heating cylinder 201 is not inhibited.

### [Procedure of Injection Molding]

The injection molding machine 1 including the above-described components performs injection molding according to the following procedure.

As is well known, the injection molding includes: a mold clamping step of closing the movable mold 109 and the fixed mold 103 and clamping the molds with high pressure; a plasticization step of heating and melting the resin pellets P inside the heating cylinder 210 to plasticize the resin; an injection step of injecting the plasticized molten resin M into the cavity formed by the movable mold 109 and the fixed mold 103 to fill the cavity with the plasticized molten resin M; a retaining step of cooling the molten resin M filled in the cavity until the molten resin M is solidified; a mold opening step of opening the molds; and a taking-out step of taking out a molded product that has been cooled and solidified inside the cavity. The above-described steps are carried out sequentially or partially in parallel to complete the injection molding of one cycle.

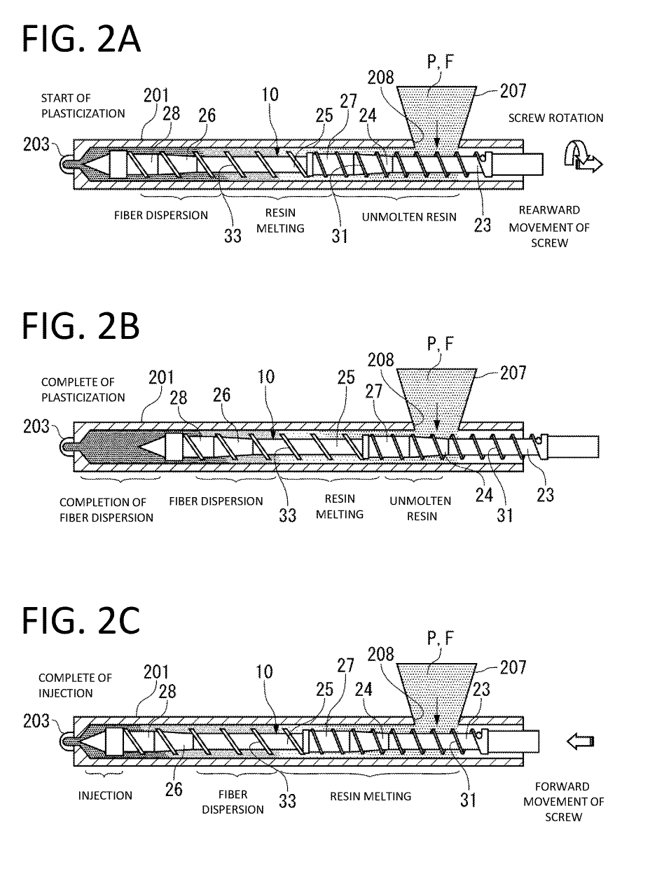

Next, out of the above-described steps, outline of the plasticization step and the injection step relating to the present embodiment are described with reference to FIGS. 2A to 2C.

### [Plasticization Step]

In the plasticization step, the resin pellets P and the reinforcing fibers F are supplied from a supply port, corresponding to the supply hopper 207, on the upstream side of the heating cylinder 201. The screw 10 is located on the downstream side of the heating cylinder 201 at the start of the plasticization, and the screw 10 moves rearward from the initial position while rotating (“start of plasticization” in FIG. 2A). When the screw 10 rotates, the resin pellets P that have been supplied between the screw 10 and the heating cylinder 201 receive shearing force and are gradually melted while being heated, and the molten resin is conveyed toward the downstream. Note that, in the present invention, the rotation (the direction) of the screw 10 in the plasticization step is defined as normal rotation. Along with the rotation of the screw 10, the reinforcing fibers F are kneaded with and dispersed into the molten resin M, and the reinforcing fibers F and the molten resin M are conveyed to the downstream. When the supply of the resin pellets P and the reinforcing fibers F and the rotation of the screw 10 are continued, the molten resin M and the reinforcing fibers F are conveyed to the downstream side of the heating cylinder 201, and are accumulated on the downstream side of the screw 10. The screw 10 moves rearward due to balance of the resin pressure of the molten resin M accumulated on the downstream side of the screw 10 and the back pressure that suppresses rearward movement of the screw 10. Thereafter, when the molten resin M of the amount necessary for one shot is measured and accumulated, the rotation and the rearward movement of the screw 10 are stopped (“completion of plasticization” in FIG. 2B).

FIGS. 2A to 2C each illustrate the state of the resin (the resin pellets P or the molten resin M) and the reinforcing fibers F at four stages of “unmolten resin”, “resin melting”, “fiber dispersion”, and “completion of fiber dispersion”. At the stage of “completion of plasticization”, the term “completion of fiber dispersion” on the downstream side of the screw 10 indicates a state in which the reinforcing fibers F are dispersed into the molten resin M and are prepared for injection, and the term “fiber dispersion” indicates a state in which the supplied reinforcing fibers F have been dispersed into the molten resin M as a result of the rotation of the screw 10. In addition, the term “resin melting” indicates a state in which the resin pellets P receive shearing force and are gradually melting accordingly, and the term “unmolten resin” indicates a state in which the resin pellets P receive shearing force but all resin pellets P have not been melted yet and insufficiently-molten resin remains. Incidentally, the reinforced resins F may be unevenly dispersed into a region at the stage of the “completion of fiber dispersion”.

### [Behavior in Constricting Section 35]

In the plasticization step, the spring-back phenomenon and the Barus effect described above occur when the mixture of the molten resin M and the reinforcing fibers F (hereinafter, simply referred to as the mixture in some cases) passes through the constricting section 35. The spring-back phenomenon and the Barus effect are described below with reference to FIGS. 3B and 3C.

The reinforcing fibers F are kneaded in the plasticized molten resin M and the fiber bundle is dispersed to some extent in the first stage 21. After the reinforcing fibers F and the molten resin M flow into the constricting section 35 that is continuous with the first stage 21 and pass through the constricting section 35, the reinforce fibers F and the molten resin M flow into the supply section 25 of the second stage 22. In other words, the mixture reaches the reduced-pressure region after being compressed in the constricting region. Therefore, the reduced-pressure region becomes expansion environment with respect to the mixture.

Focusing on the reinforcing fibers F contained in the mixture, the spring-back phenomenon occurs on the fiber bundle that is discharged, together with the molten resin M, from the constricting section 35 to the expansion environment, because the fiber bundle is reduced in pressure after drastically receiving compression force from the constricting section 35. FIG. 3B illustrates the state with the reinforcing fibers F modeled as simple line segments.

The fiber bundle B mutually have a predetermined gap that is caused by flexion and the like of the reinforcing fibers F configuring the fiber bundle B on the upstream side of the constricting section 35. When the fiber bundle B reaches the constricting section (the constricting region) 35, the reinforcing fibers F receive the compression force and are accordingly crushed to tighten the fiber bundle B. When the fiber bundle B reaches the reduced-pressure region around the supply section 25 after passing through the constricting section 35, however, the spring-back phenomenon occurs on each of the reinforcing fibers F to expand the gap between the bundled reinforcing fibers F configuring the fiber bundle B, thereby creating a state in which the fiber bundle is easily opened. Note that FIG. 3B illustrates the modeled spring-back phenomenon in the radial direction; however, the spring-back phenomenon similarly occurs in the circumferential direction actually.

In contrast, focusing on the molten resin M that passes through the constricting section 35, the Barus effect occurs on the molten resin M because the molten resin M has viscoelasticity. FIG. 3C illustrates the state with the molten resin M modeled as arrows. The molten resin M that has been conveyed through the upstream of the constricting section 35 receives compression force when passing through the constricting section (the constricting region) 35. Therefore, the molten resin M is contracted as compared with the upstream side. Note that a distance between the arrows indicates contraction and expansion. When the molten resin M reaches the reduced-pressure region around the supply section 25, namely, the expansion environment after being compressed, the molten resin M expands due to the Barus effect.

In addition, since the reinforcing fibers F float in the molten resin M and are adhered to the molten resin M, the reinforcing fibers F configuring the fiber bundle contained in the molten resin M are pulled along with the expansion of the adhered molten resin M due to the Barus effect, and the gap in the fiber bundle is accordingly enlarged. As a result, the fiber bundle becomes easily openable and the molten resin M is infiltrated into the gap to prevent rebinding of the enlarged gap between the fibers. Further, shearing force by the molten resin M easily propagates to the reinforcing fibers F inside the fiber bundle.

As mentioned above, the mixture of the molten resin M and the reinforcing fibers F that are easily openable due to synergistic effect of the spring-back phenomenon and the Barus effect receives shearing force in various directions and is kneaded while being sufficiently swirled and replaced in positions in the screw groove through the rotation of the screw when the mixture passes through the supply section 25, the compression section 26, and the measurement section 28 of the second stage 22. This promotes opening of the fibers of the fiber bundle, thereby preventing fiber-opening defect of the fibers, molding defect due to filling failure in the injection, and measurement defect in the plasticization.

The effect exerted by passage of the mixture through the constricting section 35 becomes remarkable when the shearing force is applied in two directions orthogonal to each other, as described below.

More specifically, as illustrated in FIG. 3A, when the reinforcing fiber bundle passes through the constricting section 35, shearing force Q_{H} in a direction of a rotation axis C of the screw 10 derived from the flow of the molten resin M and shearing force Q_{V} in a direction orthogonal to the rotation axis C are applied to the reinforcing fiber bundle in directions independent of each other. Therefore, even when the reinforcing fibers F and the fiber bundle contained in the molten resin M are directed in any direction, either one of the shearing force Q_{H} or the shearing force Q_{V} is applied to the fiber bundle so as to fibrillate the fiber bundle when the fiber bundle passes through the constricting section 35. This causes fiber-opening effect by passage through the constricting section 35 to be remarkable.

Incidentally, an outer diameter surface of the screw 10 configures the inner diameter side of the flow path of the mixture in the constricting section 35 and the inner diameter surface of the heating cylinder 201 configures the outer diameter side of the flow path. Therefore, when the screw 10 moves rearward in the plasticization and the measurement, the inner diameter surface of the heating cylinder 201 relatively moves forward with respect to the position of the screw 10. The relative operation causes the mixture that is located near the inner diameter surface of the heating cylinder 201 inside the constricting section 35 to receive not only the pressure of the front end part of the first stage 21 but also dragging force caused by relative movement of the inner diameter surface of the heating cylinder 201. The mixture inside the constricting section 35 is dragged out to the supply section 25 by the dragging force, which effectively prevents the mixture from clogging in the constricting section 35.

The degree of the effect facilitating fiber opening based on the spring-back phenomenon and the Barus effect depends on the ratio of the shaft diameter D₃ of the supply section 25 to the outer diameter D₂ of the constricting section 35. The degree from compression to the reduced pressure becomes large and the spring-back phenomenon and the Barus effect become remarkable as the ratio of the shaft diameter D₃ to the outer diameter D₂ (the shaft diameter D₃/the outer diameter D₂) becomes small. As a guideline, the shaft diameter D₃/the outer diameter D₂ may be preferably 0.95 or lower, more preferably 0.9 or lower, and further preferably 0.8 or lower. In contrast, when the shaft diameter D₃/the outer diameter D₂ is excessively small, stress concentration occurs on the coupling part between the shaft diameter D₃ and the outer diameter D₂ due to torsional stress by screw rotation in the plasticization or due to axial compression stress in the injection. The excess stress may break the coupling part between the shaft diameter D₃ and the outer diameter D₂. In addition, since expansion to two or more times is not typically expected for the spring-back phenomenon and the Barus effect, the shaft diameter D₃/the outer diameter D₂ may be preferably 0.5 or higher, and further preferably 0.6 or higher.

Moreover, the shaft diameter D₃ of the supply section 25 may be preferably equal to or smaller than the shaft diameter D₁ of the measurement section 27 as the terminating part of the first stage. This is because setting the shaft diameter D₃ of the supply section 25 to be equal to or smaller than the shaft diameter D₁ of the measurement section 27 as the terminating part of the first stage and making the groove volume of the supply section 25 larger than the groove volume of the measurement section 27 are effective to reduce the pressure applied to the reinforcing fibers F and the molten resin M at the terminating part of the first stage to promote opening of the reinforcing fibers F. In addition, to sufficiently release the compression applied to the reinforcing fibers F and the molten resin M at the terminating part of the first stage and to promote opening of the fibers under environment in which the reinforcing fibers F can be freely swirled and replaced in positions irrespective of the applied pressure, the shaft diameter D₃ may be more preferably smaller than the shaft diameter D₁.

### [Injection Step]

In the injection step, the screw 10 moves forward as illustrated in FIG. 2C. This closes an unillustrated backflow prevention valve provided at the front end part of the screw 10. As a result, the pressure (the resin pressure) of the molten resin M accumulated on the downstream side of the screw 10 increases, and the molten resin M is accordingly discharged from the discharge nozzle 203 toward the cavity.

Thereafter, the injection molding of one cycle is completed after the retaining step, the mold opening step, and the taking-out step are carried out. The mold clamping step and the plasticization step of next cycle are then carried out.

### [Effects]

As mentioned above, the screw 10 according to the present embodiment includes the constricting section 35, and kneads, at the second stage 22, the mixture of the reinforcing fibers F and the molten resin M in easily-openable state, thereby promoting opening of fibers of the fiber bundle. This makes it possible to prevent fiber-opening defect of the fibers, molding defect due to filling failure in the injection, and measurement defect in the plasticization.

Hereinbefore, although the present invention is described based on the embodiment, the configurations described in the above-described embodiment may be selected or appropriately modified without departing from the scope of the present invention.

For example, in the above-described embodiment, the constricting section 35 is provided at the boundary of the two-stage screw 10 including the first stage 21 and the second stage 22; however, the present invention is not limited thereto as long as the reinforcing fibers M and the molten resin M are in the mixed state and the spring-back phenomenon and the Barus effect are obtainable. The constricting section 35 may be provided in the range of the first stage 21 or in the range of the second stage 22 of the two-stage screw 10. In addition, the constricting section 35 may be provided on two or three or more positions, for example, in the range of the second stage 22 in addition to at the boundary between the first stage 21 and the second stage 22. Further, the screw to which the constricting section 35 is applied is not limited to the two-stage type, and may be of a single-stage type including one supply section and one compression section.

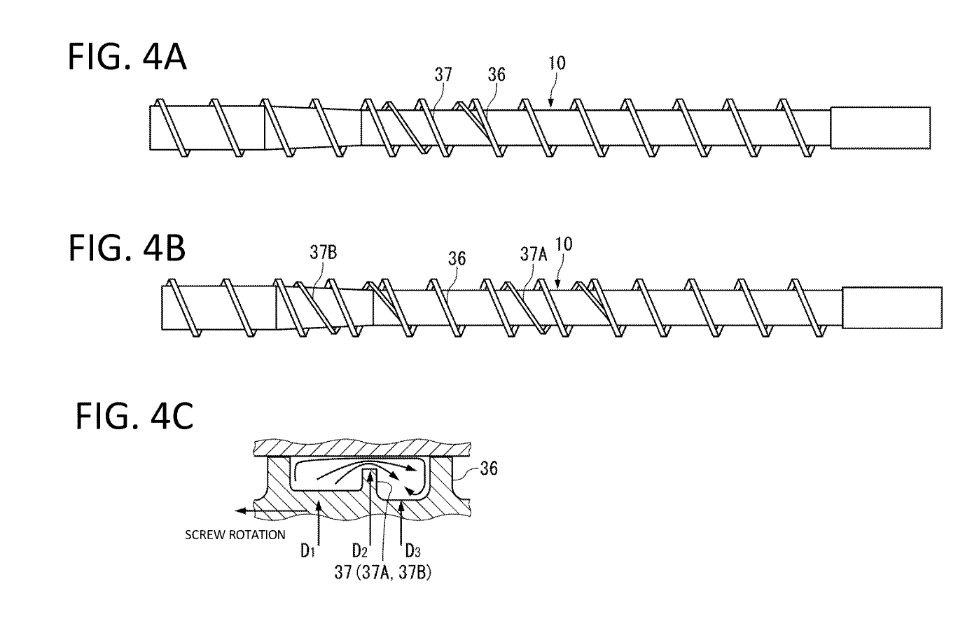

Moreover, in the present embodiment, the example in which the constricting section 35 is formed in a ring-like entire-circumferential dam shape; however, the present invention is not limited thereto. For example, as illustrated in FIGS. 4A and 4B, the constricting section 35 is not formed in a ring-like shape, and a main flight 36 and a sub-flight 37 (37A and 37B) that has an outer diameter smaller than an outer diameter of the main flight 36 may be provided on the screw 10, and the sub-flight 37 may function as the constricting section 35. Note that FIG. 4A illustrates an example in which the sub-flight 37 is provided as single stage, and FIG. 4B illustrates an example in which the sub-flight 37 is provided as double stage with an interval in between. Further, the main flight 36 corresponds to the first flight 31 or the second flight 33 as mentioned above. The sub-flight 37 has a barrier flight shape in which the lead angle thereof is set larger than the lead angle of the main flight 36 and both ends thereof are closed with respect to the main flight 36. The sub-flight 37 can achieve the effects of the present invention. The constricting section configured of the sub-flight 37 (37A and 37B) has a screw structure. Therefore, as illustrated in FIG. 4C, the sub-flight 37 serving as the constricting section has the conveying force of the resin as illustrated by an arrow in the drawing in the rotation of the screw. Even in the state in which the constricting section is easily clogged due to high content of the reinforcing fibers F, the conveying force derived from the screw structure makes it possible to allow the mixture of the reinforcing fibers F and the molten resin M to pass through the constricting section without clogging. In particular, to prevent clogging by the sub-flight 37, the size of the gap between the outer diameter of the sub-flight 37 and the inner diameter of the cylinder may be preferably 0.1 mm at minimum, and may be preferably equal to or smaller one of 8 mm and 60% of the groove depth at maximum. Even if the size of the gap is smaller than 0.1 mm, the reinforcing fibers F clog the gap, and even if the size of the gap is larger than the smaller one of 8 mm and 60% of the groove depth, the resin conveyance ability by the lead of the flight toward the downstream side is insufficient and the effect of preventing clogging is not expected. Note that the size range of the gap may be applied to a case in which the constricting section has a ring-like entire-circumferential dam shape. This makes it possible to further effectively prevent clogging at the ring-like constricting section.

When the constricting section 35 is provided at a plurality of positions, the constricting section provided on the downstream side out of the constricting sections provided at respective positions may have a large outer diameter relatively to an outer diameter of the constricting section provided on the upstream side. This case is effective to fibrillate the fiber bundle including remaining fiber mass, at the large gap between the inner diameter of the cylinder and the outer diameter of the constricting section on the upstream side and to uniformly apply, at the constricting section having a small gap on the downstream side, shearing force to the reinforcing fiber bundle that has been opened, thereby evenly dispersing the fibers into the molten resin. In particular, making the gap on the upstream side larger makes it possible to prevent breakage of the reinforcing fibers F caused by occurrence of excessively-large shearing force due to drastic deformation, when a large fiber mass that has not been opened enters the gap of the constricting section.

Further, when the constricting section is configured of the sub-flights 37A and 37B provided at a plurality of positions as illustrated in FIG. 4B, the outer diameter of each of the sub-flights 37A and 37B may be smoothly or stepwisely enlarged from the upstream side toward the downstream side. This includes some aspects. As a first aspect, the outer diameters of the respective sub-flights 37A and 37B are fixed but the outer diameter of the sub-flight 37B on the downstream side is larger than the outer diameter of the sub-flight 37A on the upstream side (on the right side in the drawing). As a second aspect, the outer diameter of the sub-flight 37A is gradually increased from the upstream end toward the downstream end, and the outer diameter of the sub-flight 37B is gradually increased from the upstream end toward the downstream end. The first aspect and the second aspect may be combined.

In addition, in the present embodiment, the expansion element of the mixture that is caused by pressure reduction of the mixture discharged from the constricting section is described as the spring-back phenomenon of the reinforcing fibers F and the Barus effect of the molten resin M. In the case of a raw material that contains a large amount of volatile gas component, however, presence of volatile component solved in the molten resin M gasified by pressure reduction may be also used as the expansion element of the molten resin M.

In addition, in the above-described embodiment, the example in which the constricting section 35 is applied to the injection molding machine of the type supplying the resin pellets P and the reinforcing fibers F together on the upstream side of the screw in the longitudinal direction is illustrated; however, the present invention is not limited thereto. For example, the constricting section 35 may be applied to an injection molding machine of a type supplying the resin pellets P on the upstream side and supplying the reinforcing fibers F on the downstream side. In this case, the resin pellets P are supplied to the supply section or the compression section of the first stage 21 and the reinforcing fibers F are supplied to the supply section of the second stage 22, with use of the two-stage screw; however, providing the constricting section 35 in the range of the second stage 22 in which the reinforcing fibers F and the molten resin M are in the mixed state makes it possible to exert the spring-back phenomenon and the Barus effect.

In addition, the resin and the reinforcing fiber applied to the present invention are not particularly limited, and widely encompass well-known materials, for example, general-purpose resins such as polypropylene and polyethylene, well-known resins such as engineering plastics including polyamide and polycarbonate, and well-known reinforcing fibers such as glass fibers, carbon fibers, bamboo fibers, and hemp fibers. Note that, to achieve the effects of the present invention remarkably, a fiber-reinforced resin containing a large amount of reinforcing fibers, for example, 10% or higher in content, may be desirable used. If the content of the reinforcing fibers exceeds 70%, however, conveyance resistance of the reinforcing fibers in the screw groove increases. In particular, when a small-diameter flight having relatively low resin conveyance ability is used, conveyance of the reinforcing fibers may become difficult, and the reinforcing fibers may block the screw groove and clog at the constricting section, which may deteriorate plasticization performance or may cause a state of being unable to perform plasticization (being unable to convey the resin). Therefore, the reinforcing fibers applied to the present invention may be preferably 10% to 70% in content, and more preferably 15% to 50%. In addition, the reinforcing fibers and the resin raw material to be supplied may be preferably supplied as the mixture of the reinforcing fibers and the raw material resin that are individually prepared, in order to remarkably achieve the effects of the present invention; however, it is possible to use a composite raw material that is obtained by integrally immersing the reinforcing fibers in the resin, without hindrance.

### REFERENCE SIGNS LIST

1 Injection molding machine
10 Screw
21 First stage
22 Second stage
23, 25 Supply section
24, 26 Compression section
27, 28 Measurement section
31 First flight
33 Second flight
35 Constricting section
36 Main flight
37, 37A, 37B Sub-flight
50 Control section
100 Mold clamping unit
101 Base frame
103 Fixed mold
105 Fixed die plate
107 Sliding member
109 Movable mold
111 Movable die plate
113 Hydraulic cylinder
115 Tie bar
117 Hydraulic cylinder
119 Ram
121 Male screw part
123 Nut
200 Plasticization unit
201 Heating cylinder
203 Discharge nozzle
207 Supply hopper
209 First electric motor
211 Second electric motor
C Rotation axis
F Reinforcing fiber
M Molten resin
P Resin pellet

1. An injection molding method, comprising:
a plasticization step of supplying a solid resin raw material and reinforcing fibers to a cylinder including a screw, and rotating the screw in a normal direction to generate a mixture of the reinforcing fibers and a molten resin, the screw being rotatable around a rotation axis and being movable forward and rearward along the rotation axis; and
an injection step of injecting the mixture into a cavity of a mold, wherein in the plasticization step,
compression force that is higher than compression force on an upstream side of a constricting region is applied to the mixture in the constricting region, the constricting region being provided in at least a portion of the screw in the rotation axis direction,
a pressure applied to the mixture passed through the constructing region is reduced in a reduced-pressure region on a downstream side of the constricting region, and
the mixture is kneaded through the rotation of the screw after the pressure applied to the mixture is reduced, wherein the screw includes,
a constricting section, a reduced-pressure section, and a kneading section, the constricting section being provided in at least a partial region through which the generated mixture passes and having an outer diameter D₂ that is larger than a shaft diameter D₁ of the screw on the upstream side of the partial region, the constricting section being formed in a ring shape having the outer diameter D₂ larger than the shaft diameter D₁ of the screw over an entire circumference, the reduced-pressure section being continuous with the constricting section on the downstream side and having a shaft diameter D₃ that is smaller than the outer diameter D₂ of the constricting section, and the kneading section being continuous with a downstream end of the reduced-pressure section and kneading the mixture,
the constricting region is provided around the constricting section inside the cylinder,
the reduced-pressure region is provided around the reduced-pressure section inside the cylinder, and
the kneading section is provided around the reduced-pressure region inside the cylinder.

2. The injection molding method according to claim 1, wherein in the plasticization step, the resin raw material and the reinforcing fibers are supplied on the upstream side of the constricting region, and the mixture is generated until the resin raw material and the reinforcing fibers reach the constricting region.

3. (canceled)

4. The injection molding method according to claim 1, wherein a ratio of the shaft diameter D₃ to the outer diameter D₂ (the shaft diameter D₃/the outer diameter D₂) is within a range of 0.5 to 0.95.

5. The injection molding method according to claim 1, wherein the shaft diameter D₃ of the reduced-pressure section is smaller than the shaft diameter D₁ of the screw on the upstream side of the constricting section.

6. A screw for an injection molding machine that is used to inject and mold a mixture of a molten resin and reinforcing fibers to generate a fiber-reinforced resin, the screw comprising:
a melting section that plasticizes and melts a solid resin raw material to generate the mixture of the molten resin and the reinforcing fibers;
a constricting section that is provided in at least a partial region through which the generated mixture passes, and has an outer diameter larger than a shaft diameter of the screw on an upstream side of the partial region;
a reduced-pressure section that is continuous with the constricting section on a downstream side, and has the shaft diameter smaller than the outer diameter of the constricting section; and
a kneading section that is continuous with a downstream end of the reduced-pressure section and kneads the mixture.

7. The screw according to claim 6, wherein the constricting section is formed in a ring shape that has the outer diameter larger than the shaft diameter of the screw over an entire circumference.

8. The screw according to claim 6, wherein
the constricting section includes a main flight and a sub-flight that has an outer diameter set smaller than an outer diameter of the main flight, and
the sub-flight has a lead angle that is set larger than a lead angle of the main flight, and has both ends that are closed with respect to the main flight.

9. An injection molding machine that injects and molds a fiber-reinforced resin, the injection molding machine comprising:
a cylinder including a discharge nozzle; and
a screw that is provided inside the cylinder, is rotatable around a rotation axis, and is movable forward and rearward along the rotation axis, wherein the screw includes
a melting section that plasticizes and melts a solid resin raw material to generate a mixture of a molten resin and reinforcing fibers,
a constricting section that is provided in at least a partial region through which the generated mixture passes, and has an outer diameter larger than a shaft diameter of the screw on an upstream side of the partial region,
a reduced-pressure section that is continuous with the constricting section on a downstream side, and has a shaft diameter smaller than the outer diameter of the constricting section, and
a kneading section that is continuous with a downstream end of the reduced-pressure section and kneads the mixture.
